(19) United States
(12) Patent Application Publication
(10) Pub. No.: US 2026/0225738 A1
(43) Pub. Date: Aug. 6, 2026

(54) Guardian:Anti-Gravity Neutralization G-Force Magnetic Field Propulsion

(71) Applicant: Cary Miller, Shobonier, IL (US)

(72) Inventor: Cary Miller, Shobonier, IL (US)

(21) Appl. No.: 19/169,055

(22) Filed: Apr. 3, 2025

Related U.S. Application Data
(60) Provisional application No. 63/753,055, filed on Feb. 3, 2025.

(51) Int. Cl. B64G 1/40; B64G 1/10

(52) U.S. Cl. CPC B64G 1/409; B64G 1/10

(57) ABSTRACT

The CP1 Guardian is a high-efficiency, field-state propulsion system designed for advanced aerospace applications. Utilizing multi-phase magnetic field interaction, Field Alignment Feedback response, and feedback-supported flight optimization, the CP1 Guardian generates sustained thrust through High-Strength Magnetic Field Propulsion, minimizing atmospheric resistance during acceleration and enabling sustained hypersonic flight. The system includes a Feedback-Supported Energy Core, an Signal Reduction Coating layer for reduced electromagnetic visibility, and a feedback-tuned aerodynamic field envelope to minimize atmospheric resistance. The system maintains stability at hypersonic velocities while ensuring operational stability in both atmospheric and orbital environments. The design integrates pattern-guided alignment between magnetic resonance and feedback, enabling dynamic field adjustments and enhanced maneuverability.

### FIELD OF INVENTION

The present invention relates to the field of aerospace.

### SUMMARY OF INVENTION

The CP1 Guardian is a high-efficiency, field-state propulsion platform designed for advanced aerospace applications. It combines multiple cutting-edge systems into a single integrated platform, including:
Feedback-Supported Energy Core—A self-sustaining energy source that draws from ambient energy fields to generate continuous power without combustion.
Multi-Phase Magnetic Propulsion Rings—These rings create thrust through High-Strength Magnetic Field Propulsion, allowing for reactionless propulsion.
Field Alignment Feedback Response System—A real-time feedback mechanism that adjusts propulsion and stability based on dynamic environmental data.
Signal Reduction Coating Layer—This reduces electromagnetic visibility and enhances Low Electromagnetic Visibility capability.
Dynamic Flight Envelope—The AI interface manages slipstream locking and magnetic field tuning to maintain stability at hypersonic and orbital speeds.
Integrated AI-Control System—The AI continuously monitors and adjusts propulsion and feedback to optimize performance and maneuverability.

The system is capable of achieving sustained hypersonic flight (Mach 50+) with minimal drag and full maneuverability in both atmospheric and orbital environments.

### BRIEF DESCRIPTION OF THE DRAWINGS

FIG. 1—External Perspective View

FIG. 2—Top View

FIG. 3—Side View

FIG. 4—AI-Enhanced Interface

FIG. 5—Field Alignment Feedback System

FIG. 6—Internal Cross-Section

FIG. 7—Energy Flow and Feedback Loop

FIG. 8A—Exploded Front View

FIG. 8B—Exploded Back View

### DETAILED DESCRIPTION

The CP1 Guardian system is a fully integrated field-state propulsion platform designed for advanced aerospace and orbital flight applications.

The core of the system is a multi-phase magnetic resonance array consisting of independently tuned propulsion assemblies, each generating a field strength exceeding 37 Tesla. The system is driven by a Feedback-Supported Energy Core, which sustains energy output through High-Strength Magnetic Field Propulsion. maintaining continuous thrust without thermal degradation.

The magnetic resonance array is dynamically adjusted using a feedback-supported field tuning module, which leverages Field Alignment Feedback from the Field Feedback Stabilization System to optimize resonance patterns and enhance coupling efficiency. The system achieves sustained hypersonic flight exceeding high-altitude flight conditions through a combination of aerodynamic envelope generation, feedback-supported inertial response, and dynamic magnetic field manipulation.

The CP1 Guardian incorporates an Signal Reduction Coating layer to minimize radar and thermal signature, utilizing bilayer graphene deposition to enhance Low Electromagnetic Visibility and reduce electromagnetic visibility. The feedback-supported tuning module includes correction and hybrid simulation capabilities, allowing the system to predict and adjust field stability under varying atmospheric and orbital conditions.

The system's Adaptive Stabilization System reduces pilot exposure to acceleration forces during high-speed maneuvers, supporting sustained human operation at extreme velocities. The feedback-tuned aerodynamic field envelope minimizes atmospheric drag and dynamically adjusts based on altitude and magnetic field density.

The CP1 Guardian also includes a field-stabilizing feedback loop to enhance magnetic field coherence and prevent drift during high-speed flight.

The Feedback-Supported Energy Core operates at a stable low-entropy operating state, sustaining energy output without degradation over extended periods.

The system's Controlled Safe State Entry mechanism is configured to decouple the resonance array and revert to a safe state using a field-Field-Phase Stabilization process, ensuring operational safety during emergency scenarios.

The CP1 Guardian is the first known platform to achieve sustained hypersonic and orbital-level flight using magnetic field coupling, establishing a new benchmark in aerospace engineering.

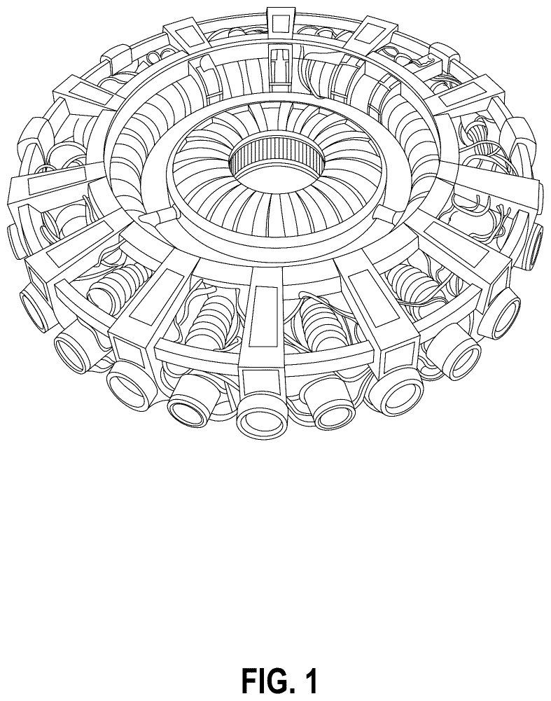

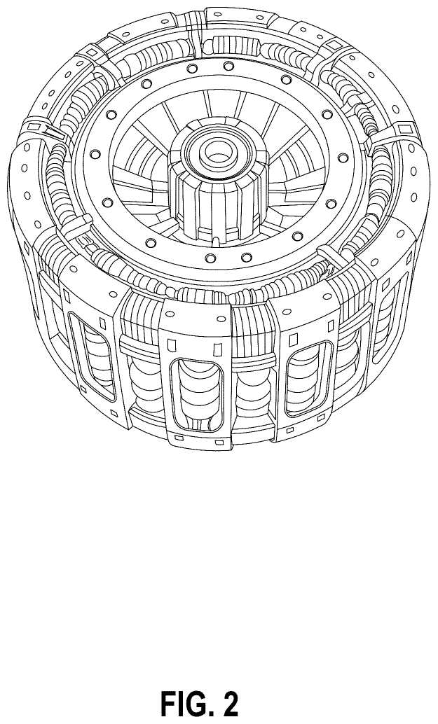

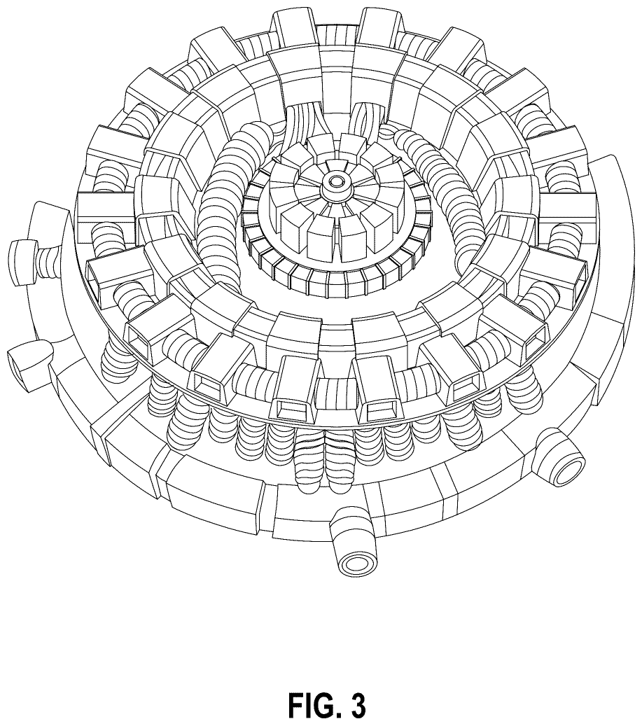

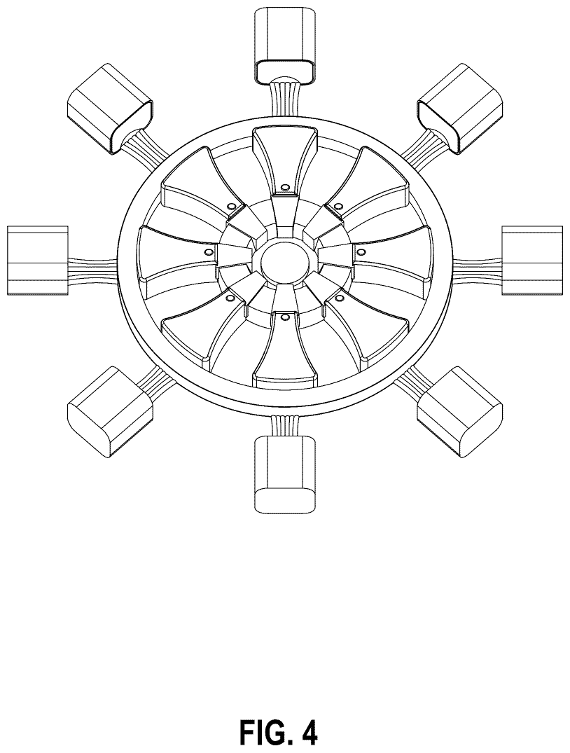

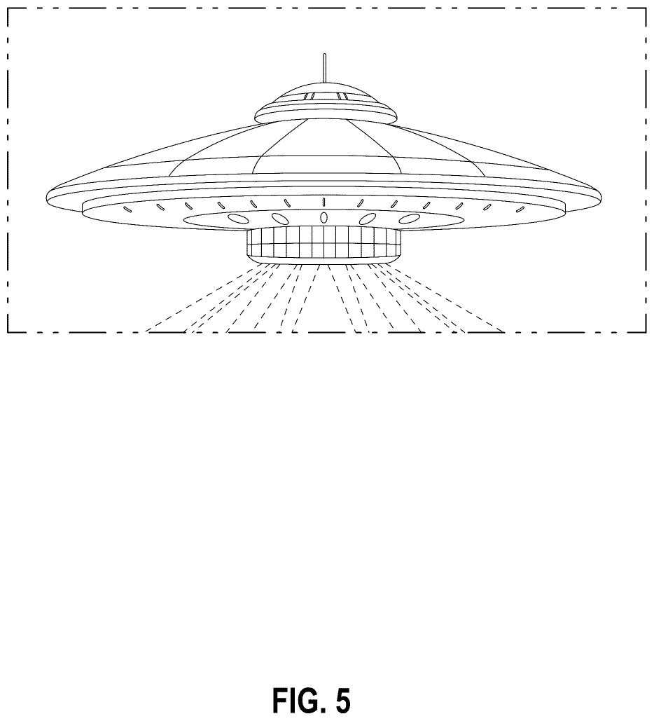

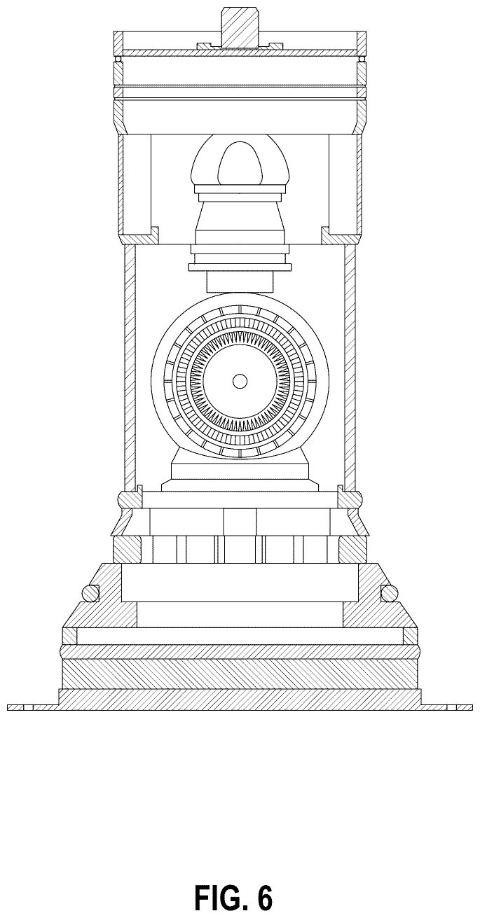

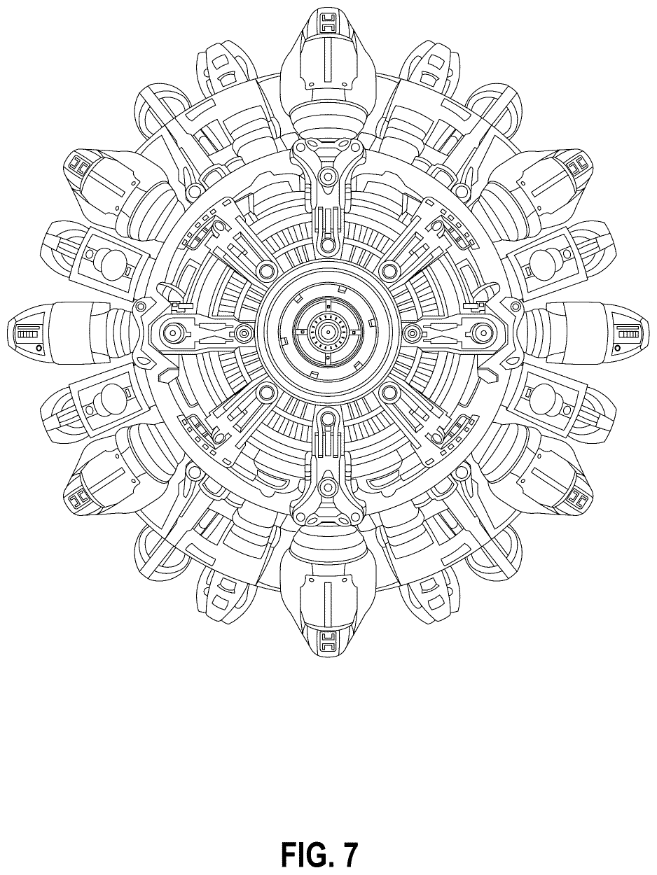

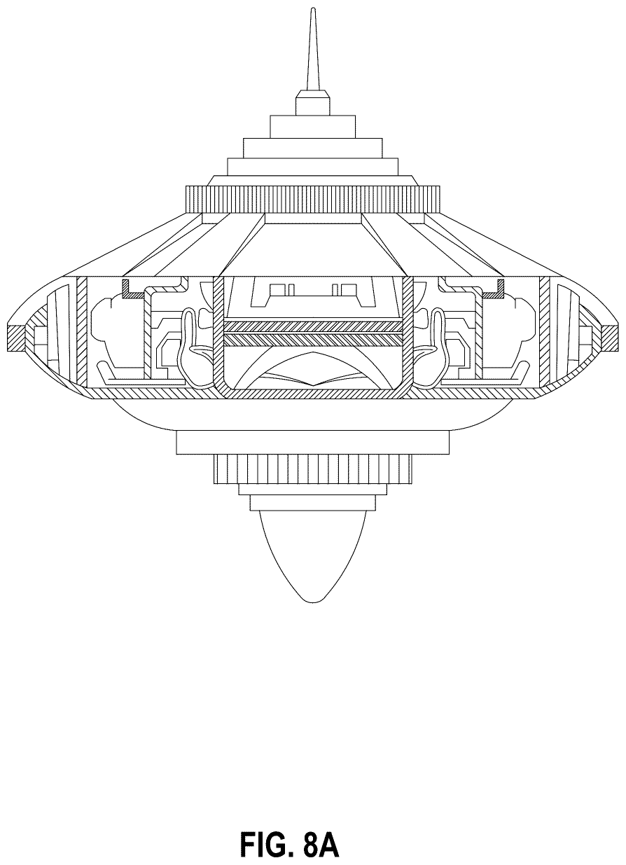

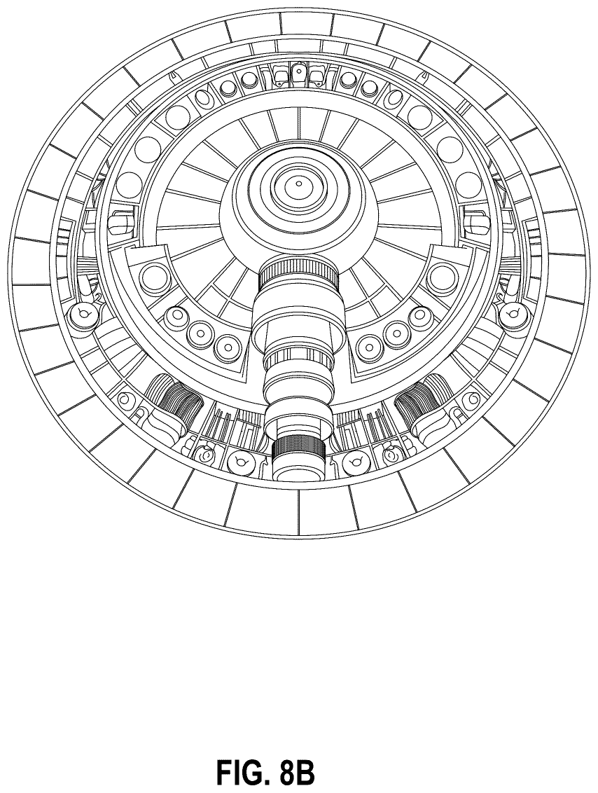

The accompany drawings illustrate the following views:
FIG. 1—External Perspective View
FIG. 2—Top View
FIG. 3—Side View
FIG. 4—AI-Enhanced Interface
FIG. 5—Field Alignment Feedback System
FIG. 6—Internal Cross-Section
FIG. 7—Energy Flow and Feedback Loop
FIG. 8A—Exploded Front View
FIG. 8B—Exploded Back View

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A field-state propulsion system comprising a multi-phase magnetic resonance array configured to generate thrust through High-Strength Magnetic Field Propulsion.

2. The system of claim 1, further comprising a feedback-supported magnetic field tuning module configured to adjust the resonance envelope dynamically.

3. The system of claim 2, wherein the magnetic field tuning module utilizes Field Alignment Feedback response from a Feedback-Supported Energy Core.

4. The system of claim 1, further comprising an Signal Reduction Coating layer to reduce electromagnetic visibility.

5. The system of claim 1, wherein the multi-phase resonance array includes a set of independently tuned propulsion assemblies configured to produce a total field strength exceeding 37 Tesla.

6. The system of claim 1, further comprising a feedback-tuned aerodynamic field envelope configured to minimize atmospheric drag at sustained hypersonic velocities.

7. The system of claim 1, wherein the system achieves sustained flight capability at speeds exceeding high-altitude flight conditions.

8. The system of claim 1, further comprising a Field Feedback Stabilization System configured to enhance magnetic alignment and feedback response.

9. The system of claim 1, wherein the feedback-supported tuning module adjusts resonance frequency to optimize thrust and minimize turbulence.

10. The system of claim 1, further comprising a Dynamic Flight Optimization Platform configured to predict and adjust flight envelope stability.

11. The system of claim 1, wherein the Feedback-Supported Energy Core operates at a stable low-entropy operating state to sustain energy output without thermal degradation.

12. The system of claim 1, further comprising a field-stabilizing feedback loop configured to enhance magnetic field stability.

13. The system of claim 1, wherein the Signal Reduction Coating layer is applied using bilayer graphene deposition to reduce electromagnetic signature.

14. The system of claim 1, further comprising an Adaptive Stabilization System configured to reduce pilot exposure to acceleration forces.

15. The system of claim 1, wherein the feedback-supported tuning module communicates with a memory system to retain adaptive resonance profiles.

16. The system of claim 1, wherein the system is configured for both atmospheric and orbital flight using a single field envelope.

17. The system of claim 1, further comprising a Stability Tuning System configured to adjust tuning dynamically to compensate for drift.

18. The system of claim 1, wherein the aerodynamic envelope is dynamically adjusted based on atmospheric density and magnetic field alignment.

19. The system of claim 1, wherein the system achieves continuously reinforced energy output through field-state magnetic coupling.

20. The system of claim 1, further comprising a field-Field-Phase Stabilization mechanism to enable Controlled Safe State Entry mode with manual reset capability.
